(19) United States
(12) Patent Application Publication
(10) Pub. No.: US 2008/0285416 A1
(43) Pub. Date: Nov. 20, 2008

(54) Method for Multilevel Recording Information on a Record Carrier a Record Carrier and a Recording Device

(75) Inventors: Erwin Rinaldo Meinders, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/571,538

(22) PCT Filed: Jun. 23, 2005
(86) PCT No.: PCT/IB05/52059

§ 371 Date: Jan. 2, 2007

(30) Foreign Application Priority Data
Jul. 7, 2004 (EP) 04103213.7

(51) Int. Cl. G11B 7/00

(52) U.S. Cl. 369/94; 369/100

(57) ABSTRACT

A record carrier comprises three layers that react with each other when irradiated to form a mark on the record carrier. The three layers are separated by a two separating layers that prevent direct contact of the three layers thus providing stability to the record carrier. By irradiating one or both separating layers a region of those separating layers is destroyed or altered whereby an opening is created and the reaction of the layers adjacent to the separating layer is no longer prevented in that region and a mark can be formed. Since either one or two reactions can take place if one or both separating layers are destroyed or altered multiple reflection levels for a mark can be obtained, thus enabling multilevel recording where a single mark can represent more information compared to the situation where only two reflection levels can be obtained. The size of the resulting opening determines the size of the mark and can thus be used to create a very small mark allowing high density recordings.

The invention relates to a method for recording information on an optical disc comprising a first layer of a first material and a second layer of a second material, the method comprising irradiating a region of the optical disc with a dose of laser energy where the first material of the first layer reacting with the second material of the second layer in the region irradiated with the dose of laser energy, to a record carrier comprising a first layer of a first material and a second layer of a second material, and to a recording device for recording information on an optical disc comprising a control circuit for controlling a dose of irradiation emitted by a laser and a detection circuit for detecting a type of optical disc.

Recording information can be performed on a record carrier comprising a first layer of Cu and a second layer of Si.

The layers are located on top of each other and in direct physical contact.

When the layers are irradiated with a dose of laser energy in a region the first layer and the second layer are heated in that region. When the temperature is high enough both layers melt or in another way break-down by a temperature-induced or photon-induced reaction and, in the region of the high temperature, the materials of the layers react with each other to form CuSi. The reflectivity of CuSi differs from the surrounding area outside the region where the melting occurred. Thus information is recorded by differences in reflectivity of the recording materials.

This method has the disadvantage that the Cu and Si layers can, even without being irradiated by a dose of laser energy, react with each other, resulting in a loss of contrast which in turn leads to less robust readability and long term stability. Further more the method does not allow multilevel recording.

It is the objective of the present invention to provide a method where the layers will not react with each other unless irradiated by a dose of laser energy and at the same time allows multilevel recording.

In order to achieve this objective the invention is characterized in that a third layer, located between the first layer and the second layer when irradiated with a first dose of laser energy enables the reaction between the first material and the second material in the region irradiated by the first laser dose and that a fourth layer, located between a fifth layer of the first material and the second layer, when irradiated with a second dose of laser energy enables a further reaction between the first material and the second material in the region irradiated by the second laser dose.

By separating the three recording layers by two layers, the third layer and the fourth layer there is no reaction possible unless the third layer and/or fourth layer is broken down by irradiation by a dose and/or a further dose of laser energy. In the region where the third layer is broken down the reaction between the first layer and the second layer can take place. In the region where the fourth layer is broken down the reaction between the fifth layer and the second layer can take place. In the other regions the first layer and the second layer remain separated by the third layer and the second and the fifth layer remain separated by the fourth layer any reaction leading to a reduction in contrast is prevented.

By providing two separation layers between three recording layers multiple levels of reflection are obtained. When only the third layer is broken down a first reflection level is achieved. When only the fourth layer is broken down a second reflection level is achieved. When both the third and fourth layer are broken down a third level is achieved.

Robust readability, long term stability and multi level recording are thus achieved.

When this description refers to the ‘break down’ of the third, fourth or separating layer ‘break down’ must be construed to also mean ‘deterioration’, ‘melting’, ‘evaporation’, ‘chemical break down’ or ‘mechanical break down’. The important element is that both the third layer and the fourth layer in a first state prevent a reaction between the materials of the adjacent layers, while in the second, break down, state the third layer and/or the fourth layer no longer prevents the reaction in the region where the third layers and/or fourth layer is broken down.

An embodiment of the invention is characterized in that the reaction or the further reaction is a melting to form an alloy of the first material and the second material.

The change in contrast can be achieved by choosing the first material of the first and fifth layer and the second material of the second layer such that they will produce a change in contrast when mixed. This may be organic and inorganic materials. Since the third layer and the fourth layer both separate the two materials, the invention allows combinations of materials to be chosen that would normally react with each other when in contact, even at regular room temperature instead of elevated temperatures as created by the irradiation.

Further more combinations of materials can be chosen that react when irradiated with a dose of laser energy that is lower than the dose of laser energy needed to break down the third layer and/or the fourth layer.

When choosing a combination of materials that react when irradiated with a dose of laser energy that is higher than the dose of laser energy needed to break down one or both separating layers, i.e. the third layer and/or the fourth layer, the separating layers will be broken down in a larger region than where the materials of the first, second and fifth layer react. This however still provides the advantage of the definition of the maximum area where the materials of the first and second layer and the second and fifth layer will react, improving the long term stability and putting an upper limit to the reduction of contrast.

A wider choice of materials is possible.

A further embodiment of the invention is characterized in the reaction or the further reaction is a melting to form an alloy of the first material and the second material. By elevating the temperature of the materials on both sides of the third layer, while at the same time breaking down the third layer the molten material in the first layer can form an alloy with the molten material in the second layer. By elevating the temperature of the materials on both sides of the fourth layer, while at the same time breaking down the fourth layer the molten material in the fifth layer can form an alloy with the molten material in the second layer. By elevating the temperature of the first, second and fifth layer at the same time while at the same time breaking down the third and fourth layer the molten material in the first and fifth layer can form an alloy with the molten material in the second layer thus creating a different reflection level compared to a reaction between the first and second layer only. Also the increased temperature can induce interlayer diffusion. The dose of laser energy applied to the layers has the shape of a bell curve. Because temperature is highest in the center of the region and drops off going radial outwards from the center of the region the melting and thus the formed alloy might not be uniform. The separating layers, i.e. the third layer and the fourth layer form, with the proper choice of material, an aperture between the layers defining the region where the reaction by melting can occur. The increased temperature of the materials in the other layers outside the region defined by the aperture in the third layer, will not lead to any reaction between the first layer and the second layer because the intact third layer prevents this reaction. The same applies to the a reaction between the fifth layer and the second layer outside the aperture where a reaction is prevented by the fourth layer. This results in a better defined region where the alloy is formed and hence improved readability of the information on the record carrier. Using materials that form an alloy allows the information to be stored in a stable alloy, resisting aging of the record carrier.

In addition, because of the dose of laser energy having a shape of a bell curve, the aperture in the fourth layer can have a different size than the aperture in the third layer. This is the result of the reduced dose for the layers furthest away from the entry point of the laser beam into the record carrier. AN appropriate selection of the material of the separating layers allows the control of the size of the apertures thus correcting for differences in the dose of energy received by the layers.

A further embodiment of the invention is characterized in that the reaction is enabled by permanently altering the region in the third layer and that the further reaction is enabled by permanently altering the region in the fourth layer. Permanent altering may be mechanical deformation, thermally induced degradation, or photo-induced degradation, etc.

By permanently altering the region in the third layer a write once record carrier is obtained, resulting in permanently stored information.

A further embodiment is characterized in that the permanently altering is achieved by irradiating an organic material in the third layer or the fourth layer.

By choosing an organic material, such as a currently commonly used organic dye used in optical recording for the third layer and/or fourth layer, the third layer and/or fourth layer can be formed such that when irradiated the material is destroyed. The dye can be tuned to the color of the laser such that the appropriate amount of irradiation is absorbed. The absorption influences the temperature together with the dose of irradiation. The material of the first layer, the material of the second layer and the material of the fifth layer each have a, for that material particular, absorption. The absorption of the first, second and fifth layer are fixed by the choice of the materials for the first and second layer. The laser beam radiation passes through the five layers. The radiation first passes through the first layer, then through the third layer, then through the second layer, then through the fourth layer and then through the fifth layer. Each layer absorbs a fraction of the radiation. Consequently the irradiation is reduced the further the radiation passes through the layers. In order to control the temperature increase caused by the irradiation of the layers, the absorption can be adjusted so that the layers absorb the right amount of energy and reach the correct temperature for the desired reaction to occur.

A further embodiment of the invention is characterized in that the third layer and the fourth layer requires a higher dose of laser energy for enabling the reaction than required for the reaction of the first material with the second material.

The dose of laser energy applied to the layers has the shape of a bell curve. The temperature in the region irradiated by the laser is there fore not uniform but has a relatively small center with a higher temperature and a area around the center of the region where the temperature is lower. When choosing a material for the third layer that requires a higher dose of laser energy to be broken down, the area where the third layer breaks down will be limited to the center of the region irradiated by the laser. The area where the third layer breaks down will consequently be smaller than the total region irradiated. The reaction between the material of the first layer and the material of the second layer will be restricted to the area where the third layer breaks down so that the area of the reaction between the material of the first layer and the material of the second layer will also be smaller than the total region irradiated by the laser. In this way the reaction between the material of the first layer and the material of the second layer is limited by size of aperture in third layer not by melting/reaction characteristics of the materials of the first and second layers.

When choosing a material for the fourth layer that requires a higher dose of laser energy to be broken down, the area where the fourth layer breaks down will be limited to the center of the region irradiated by the laser. The area where the fourth layer breaks down will consequently be smaller than the total region irradiated. The reaction between the material of the fifth layer and the material of the second layer will be restricted to the area where the fourth layer breaks down so that the area of the reaction between the material of the fifth layer and the material of the second layer will also be smaller than the total region irradiated by the laser. In this way the reaction between the material of the fifth layer and the material of the second layer is limited by size of aperture in fourth layer not by melting/reaction characteristics of the materials of the first and second layers.

The marks thus created by the reaction will also be smaller than the total region irradiated.

In other words: marks that are smaller than the spot size of the laser used to write the mark can be written on the record carrier. Smaller marks allow more marks to be recorded on the record carrier, resulting in a higher storage capacity of the record carrier because both in a tangential as well as radial direction the density can be increased. Smaller marks also enables the writing of a two-dimensional data pattern.

Further more because the reflection of the record carrier is now influenced in multiple layers the effects on the reflection sum up to new reflection levels not encountered when using a single separating layer between two reacting layers. This enables multilevel recording where multiple levels of reflection represent multiple values used to store user data.

It must be noted that the absorption plays an important role in energy absorption from the irradiation. Thus even though the third layer receives less irradiation than the layer above the third layer when the irradiation originates from above, a higher absorption still results in a shift of the temperature distribution in the region of the third layer that is irradiated to a higher temperature than the first layer and the second layer in that region. A second effect that causes a temperature rise in the third (interface) layer is heat diffusion. This heat diffusion takes place from the first or the second layer.

This interacts with the temperature at which the third layer is broken down in that several advantages can be obtained when compared to a particular material for the third layer as a reference point:

The idea is that the aperture created in the third layer is smaller than the optical spot by proper selection of the materials in the recording stacks. Two effects play an important role in achieving the temperature distribution (and thus creating the aperture) in the third layer: thermal properties of the recording stack (heat diffusion) and laser light absorption (direct heating). The break-down temperature is here defined as the temperature at which the first layer and the second layer react to form a stable mark.

This also applies to the fourth layer in relation to the second layer and fifth layer. Even though the fourth layer receives less irradiation than the layer above the fourth layer when the irradiation originates from above, a higher absorption still results in a shift of the temperature distribution in the region of the fourth layer that is irradiated to a higher temperature than the fifth layer and the second layer in that region. A second effect that causes a temperature rise in the third (interface) layer is heat diffusion. This heat diffusion takes place from the fifth or the second layer.

The idea is that the aperture created in the fourth layer is smaller than the optical spot by proper selection of the materials in the recording stacks. Two effects play an important role in achieving the temperature distribution (and thus creating the aperture) in the fourth layer: thermal properties of the recording stack (heat diffusion) and laser light absorption (direct heating). The break-down temperature is here defined as the temperature at which fifth layer and the second layer react to form a stable mark

For each of the separating layers two different situations can be distinguished:

The separating layer is absorbent. (heat diffusion plus direct heating)

a material with a higher break down temperature can be chosen for the separating layer when, for the same irradiation, a lower absorption is chosen.

a material with a higher break down temperature can be chosen for the separating layer when, for the same irradiation, a higher absorption is chosen and if the purpose of the separating layer is only to achieve chemical stability (barrier) at room temperature).

a material with a lower break down temperature can be chosen for the separating layer when, for the same irradiation, a higher absorption is chosen.

a material with a lower break down temperature can be chosen for the separating layer when, for the same irradiation, a lower absorption is chosen and if the separating layer is only meant for achieving chemical stability at lower temperature.

a material with the same break down temperature can be chosen for the separating layer and will, for the same irradiation, result in smaller openings in the separating layer when a lower absorption is chosen

a material with the same break down temperature can be chosen for the separating layer and will, for the same irradiation, result in larger openings in the separating layer when a higher absorption is chosen.

The separating layer is semi transparent (only heat diffusion)

a material with a higher break down temperature can be chosen for the separating layer. Heat diffusion causes thermal break down of the separating layer.

a material with a lower break down temperature can be chosen for the separating layer in case only a stable reaction barrier at room temperature is wanted.

The absorption of organic dyes can for instance be controlled in relation to the color of the radiation from the laser.

A further advantage of the situation where the separating layer requires a higher dose of laser energy for enabling the reaction than required for the reaction of the first material with the second material is that cross write effects are minimized. Because of the bell shape of the temperature distribution and the limitation to the central region of the irradiated region of the break down of the separating layer, the adjacent areas, for instance adjacent tracks, do not receive enough energy through irradiation to reach the point where the separating layer is broken down. Thus, even though the materials of the first and second layers in the adjacent regions receive enough radiation to reach a temperature where a reaction could occur, the separating layer will prevent any changes in the adjacent regions since the separating layer will not reach the temperature required for the local break down of separating layer in the adjacent regions. In this way the both small marks can be written and cross write effects from writing in adjacent areas are prevented.

A further embodiment is characterized in that the first material is Si and that the second material is Cu

Si and Cu have been found to be suitable inorganic recording materials. The separating layers add stability to a record carrier using Si and Cu as recording materials, resulting in a more durable record carrier.

A further embodiment is characterized in that the first material is Bi and that the second material is Sn

Bi and Sn have been found to be suitable inorganic recording materials. The separating layers add stability to a record carrier using Bi and Sn as recording materials resulting in a more durable record carrier.

A further embodiment is characterized in that the first material is In and that the second material is Sn

In and Sn have been found to be suitable inorganic recording materials. The separating layers add stability to a record carrier using In and Sn as recording materials resulting in a more durable record carrier.

A further embodiment is characterized in that the third layer and the fourth layer comprises a third material selected from the group of ZnS—SiO2, SiC, Al2O3, Si3N4, SiO2, C, KCl, LiF, NaCl, Pt, Au, Ag, the application depending on optical properties needed (wavelength of the system)

Each member of the group of ZnS—SiO2, SiC, Al2O3 and Si3N4 etc. was found to be a suitable material for the separating layers. It forms a barrier preventing reactions between the first material and the second material as long as the separating layer is locally not broken down in a region. Once the separating layer is broken down in a region the material of the separating layer no longer prevents reactions between the first material and the second material in that region. The materials ZnS—SiO2 SiC, Al2O3, Si3N4, etc. were found to break down by irradiating them with a dose of laser energy. The material for the separating layer is selected from the group of ZnS—SiO2 SiC, Al2O3, Si3N4 such that the breakdown occurs at the appropriate temperature, depending on the reaction temperature of the materials of the adjacent layers. As explained before the temperature where the break down occurs of the material of the separating layer is preferably higher than the temperature at which the reaction between the materials of the adjacent layers occurs in order to obtain marks that are smaller than the marks obtained when no separating layer would be present, but a lower temperature where the break down of the separating layer occurs can also be used advantageously, for instance to obtain a more durable record carrier.

A further embodiment is characterized in that the third layer comprises a third material form the group Pt, Au, Ag. (absorbing third layer)

These elements are suitable materials for the interface layer.

A further embodiment is characterized in that the information is recorded using multilevel recording by creating a first level using the reaction between the first layer and the second layer and by creating a second level using the further reaction between the second layer and the fifth layer.

The precise control of the size of the mark using this method allows multi level recording to be used when using the method according to the invention. The reflection of the marks depend on which layers are allowed to react with each other by destroying the one or both separating layers. Further more, because smaller marks can be obtained, a series of successive directly adjacent marks can be used to obtain multi level recording in the same area as a regular sized mark.

A further embodiment is characterized in that the multilevel recording is performed by writing multiple overlapping marks.

Once the separating layer is broken down in a region it stays broken down and is not significantly effected by further doses of laser energy being applied to the region.

It is thus possible to regulate the size of the mark by writing a first mark and successively, either immediately after writing the first mark or after one or more revolutions of the record carrier in case of a record carrier with circular or spiral tracks, writing a further mark that overlaps with the first mark to the desired amount.

The size of the mark can be slightly increased by overlapping the second mark substantially with the first mark, for instance if the overlap is 90% the size of the resulting mark will be 110% of the size of the first mark. By varying the amount of overlap between 100% and 0% the size of the resulting mark can be adjusted between 100% and 200% of the first mark. Of course a third or further mark can add to the size of the resulting mark until the desired size of the mark is reached.

A record carrier according to the invention is characterized in that a third layer of a third material is located between the first layer and the second layer that enables a reaction between the first material and the second material in a region when irradiated in that region and that a fourth layer of the third material is located between the second layer and a fifth layer where the fourth layer enables a further reaction between the first material in the fifth layer and the second material in the second layer.

By separating the recording layers by separating layers there is no reaction possible unless one or both separating layers are broken down by irradiation by a dose of laser energy. In the region where one or both separating layers are broken down the reaction between the layer with the first material and the layer with the second material can take place. In the other regions those layers adjacent to the separating layers remain separated by the separating layer and any reaction leading to a reduction in contrast is prevented.

By providing multiple layers separated by multiple separating layers multiple reflection levels for the same mark size can be obtained.

Robust readability, long term stability and multi level recording are thus achieved.

A further embodiment of the record carrier is characterized in that the reaction and the further reaction is a chemical reaction.

The change in contrast can be achieved by choosing the first material of the first and fifth layer and the second material of the second layer such that they will produce a change in contrast when mixed. This may be organic and inorganic materials. Since the third layer and the fourth layer both separate the two materials, the invention allows combinations of materials to be chosen that would normally react with each other when in contact, even at regular room temperature instead of elevated temperatures as created by the irradiation.

Further more combinations of materials can be chosen that react when irradiated with a dose of laser energy that is lower than the dose of laser energy needed to break down the third layer and/or the fourth layer.

When choosing a combination of materials that react when irradiated with a dose of laser energy that is higher than the dose of laser energy needed to break down one or both separating layers, i.e. the third layer and/or the fourth layer, the separating layers will be broken down in a larger region than where the materials of the first, second and fifth layer react. This however still provides the advantage of the definition of the maximum area where the materials of the first and second layer and the second and fifth layer will react, improving the long term stability and putting an upper limit to the reduction of contrast. A wider choice of materials is possible.

A further embodiment of the record carrier is characterized in that the third layer and the fourth layer requires a higher dose of laser energy for enabling the reaction than required for the reaction of the first material with the second material.

The dose of laser energy applied to the layers has the shape of a bell curve. The temperature in the region irradiated by the laser is there fore not uniform but has a relatively small center with a higher temperature and a area around the center of the region where the temperature is lower. When choosing a material for the third layer that requires a higher dose of laser energy to be broken down, the area where the third layer breaks down will be limited to the center of the region irradiated by the laser. The area where the third layer breaks down will consequently be smaller than the total region irradiated. The reaction between the material of the first layer and the material of the second layer will be restricted to the area where the third layer breaks down so that the area of the reaction between the material of the first layer and the material of the second layer will also be smaller than the total region irradiated by the laser. In this way the reaction between the material of the first layer and the material of the second layer is limited by size of aperture in third layer not by melting/reaction characteristics of the materials of the first and second layers.

When choosing a material for the fourth layer that requires a higher dose of laser energy to be broken down, the area where the fourth layer breaks down will be limited to the center of the region irradiated by the laser. The area where the fourth layer breaks down will consequently be smaller than the total region irradiated. The reaction between the material of the fifth layer and the material of the second layer will be restricted to the area where the fourth layer breaks down so that the area of the reaction between the material of the fifth layer and the material of the second layer will also be smaller than the total region irradiated by the laser. In this way the reaction between the material of the fifth layer and the material of the second layer is limited by size of aperture in fourth layer not by melting/reaction characteristics of the materials of the first and second layers.

The mark thus created by the reaction will also be smaller than the total region irradiated.

In other words: marks that are smaller than the spot size of the laser used to write the mark can be written on the record carrier. Smaller marks allow more marks to be recorded on the record carrier, resulting in a higher storage capacity of the record carrier because both in a tangential as well as radial direction the density can be increased.

It must be noted that the absorption plays an important role in energy absorption from the irradiation. Thus even though the third layer receives less irradiation than the layer above the third layer when the irradiation originates from above, a higher absorption still results in a shift of the temperature distribution in the region of the third layer that is irradiated to a higher temperature than the first layer and the second layer in that region. A second effect that causes a temperature rise in the third (interface) layer is heat diffusion. This heat diffusion takes place from the first or the second layer.

This interacts with the temperature at which the third layer is broken down in that several advantages can be obtained when compared to a particular material for the third layer as a reference point:

The idea is that the aperture created in the third layer is smaller than the optical spot by proper selection of the materials in the recording stacks. Two effects play an important role in achieving the temperature distribution (and thus creating the aperture) in the third layer: thermal properties of the recording stack (heat diffusion) and laser light absorption (direct heating). The break-down temperature is here defined as the temperature at which the first layer and the second layer react to form a stable mark.

This also applies to the fourth layer in relation to the second layer and fifth layer. Even though the fourth layer receives less irradiation than the layer above the fourth layer when the irradiation originates from above, a higher absorption still results in a shift of the temperature distribution in the region of the fourth layer that is irradiated to a higher temperature than the fifth layer and the second layer in that region. A second effect that causes a temperature rise in the third (interface) layer is heat diffusion. This heat diffusion takes place from the fifth or the second layer.

The idea is that the aperture created in the fourth layer is smaller than the optical spot by proper selection of the materials in the recording stacks. Two effects play an important role in achieving the temperature distribution (and thus creating the aperture) in the fourth layer: thermal properties of the recording stack (heat diffusion) and laser light absorption (direct heating). The break-down temperature is here defined as the temperature at which fifth layer and the second layer react to form a stable mark

For each of the separating layers two different situations can be distinguished:

The separating layer is absorbent. (heat diffusion plus direct heating)

a material with a higher break down temperature can be chosen for the separating layer when, for the same irradiation, a lower absorption is chosen.

a material with a higher break down temperature can be chosen for the separating layer when, for the same irradiation, a higher absorption is chosen and if the purpose of the separating layer is only to achieve chemical stability (barrier) at room temperature).

a material with a lower break down temperature can be chosen for the separating layer when, for the same irradiation, a higher absorption is chosen.

a material with a lower break down temperature can be chosen for the separating layer when, for the same irradiation, a lower absorption is chosen and if the separating layer is only meant for achieving chemical stability at lower temperature.

a material with the same break down temperature can be chosen for the separating layer and will, for the same irradiation, result in smaller openings in the separating layer when a lower absorption is chosen

a material with the same break down temperature can be chosen for the separating layer and will, for the same irradiation, result in larger openings in the separating layer when a higher absorption is chosen.

The separating layer is semi transparent (only heat diffusion)

a material with a higher break down temperature can be chosen for the separating layer. Heat diffusion causes thermal break down of the separating layer.

a material with a lower break down temperature can be chosen for the separating layer in case only a stable reaction barrier at room temperature is wanted.

The absorption of organic dyes can for instance be controlled in relation to the color of the radiation from the laser.

A further advantage of the situation where the third and fourth layer requires a higher dose of laser energy for enabling the reaction than required for the reaction of the first material with the second material is that cross write effects are minimized. Because of the bell shape of the temperature distribution and the limitation to the central region of the irradiated region of the break down of the separating layer, the adjacent areas, for instance adjacent tracks, do not receive enough energy through irradiation to reach the point where the separating layer is broken down. Thus, even though the materials of the first, second and fifth layers in the adjacent regions receive enough radiation to reach a temperature where a reaction could occur, the separating layers will prevent any changes in the adjacent regions since the separating layers will not reach the temperature required for the local break down of separating layers in the adjacent regions. In this way the both small marks can be written and cross write effects from writing in adjacent areas are prevented.

A further embodiment of the record carrier is characterized in that the first material is Si and that the second material is Cu

Si and Cu have been found to be suitable inorganic recording materials. The separating layers add stability to a record carrier using Si and Cu as recording materials, resulting in a more durable record carrier.

A further embodiment of the record carrier is characterized in that the first material is Bi and that the second material is Sn

Bi and Sn have been found to be suitable inorganic recording materials. The separating layers add stability to a record carrier using Bi and Sn as recording materials resulting in a more durable record carrier.

A further embodiment of the record carrier is characterized in that the first material is In and that the second material is Sn

In and Sn have been found to be suitable inorganic recording materials. The separating layers add stability to a record carrier using In and Sn as recording materials resulting in a more durable record carrier.

A further embodiment of the record carrier is characterized in that the third layer and fourth layer comprises a material selected from the group of ZnS, SiO2 SiC, Al2O3, SiN

Each member of the group of ZnS, SiO2 SiC, Al2O3 and SiN was found to be a suitable material for the third and fourth layer that separates the first layer from the second layer and the second layer from the fifth layer on the record carrier. It forms a barrier preventing reactions between the first layer and the second layer as long as the third layer is locally not broken down in a region, and between the second layer and the fourth layer as long as the fourth layer is locally not broken down in a region. Once the separating layer is broken down in a region the material of the separating layer no longer prevents reactions between the adjacent layers in that region. The materials ZnS, SiO2 SiC, Al2O3, SiN were found to break down by irradiating them with a dose of laser energy. The material for the third and fourth layer is selected from the group of ZnS, SiO2 SiC, Al2O3, SiN such that the breakdown occurs at the appropriate temperature, depending on the reaction temperature of the materials of the first, second and fifth layer. As explained before the temperature where the break down occurs of the material of the third and fourth layer is preferably higher than the temperature at which the reaction between the materials of the first, second and fifth layer occurs in order to obtain marks that are smaller than the marks obtained when no separating layer would be present, but a lower temperature where the break down of the separating layer occurs can also be used advantageously, for instance to obtain a more durable record carrier.

An embodiment of a recording device is characterized in that the control circuit, when the detection circuit detects a record carrier comprising a first layer of a first material and a second layer of a second material where a third layer of a third material is located between the first layer and the second layer and where a fourth layer of a third material is located between the second layer and a fifth layer of the first material where that third layer enables a reaction between the first material and the second material in a region when that third layer is irradiated in that region with a dose of irradiation, adjusts the dose of irradiation such that the third layer enables the reaction where that fourth layer enables a further reaction between the first material and the second material in the region when that fourth layer is irradiated in that region with a further dose of irradiation, adjusts the further dose of irradiation such that the fourth layer enables the reaction.

A recording device must adjust the parameters associated with the write strategy to comply with the requirements with the record carrier on which data is to be recorded.

For this the recording device must be able to detect the type of record carrier. Alternatively the recording device can be made suitable for a single type of record carrier only so that no detection is required, or other known methods can be applied to determine appropriate parameters for the recording process.

The parameters are then provided to a control circuit that controls the laser device that emits the dose of laser energy to adjust the recording process to suit the record carrier to be recorded.

The invention will now be described based on figures.

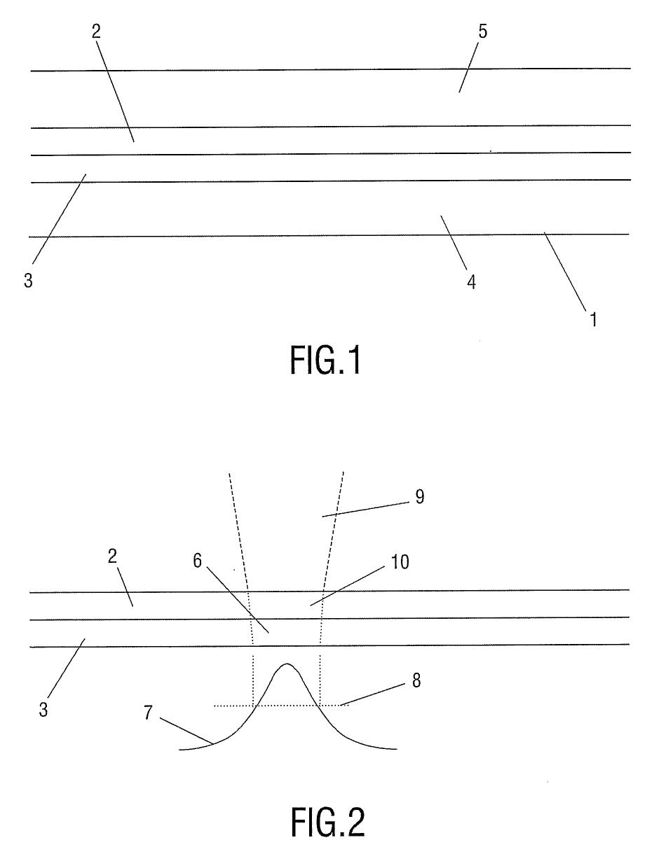

FIG. 1 shows the cross section of a record carrier of the prior art.

FIG. 2 shows the irradiation of a record carrier to write a mark on a record carrier of the prior art.

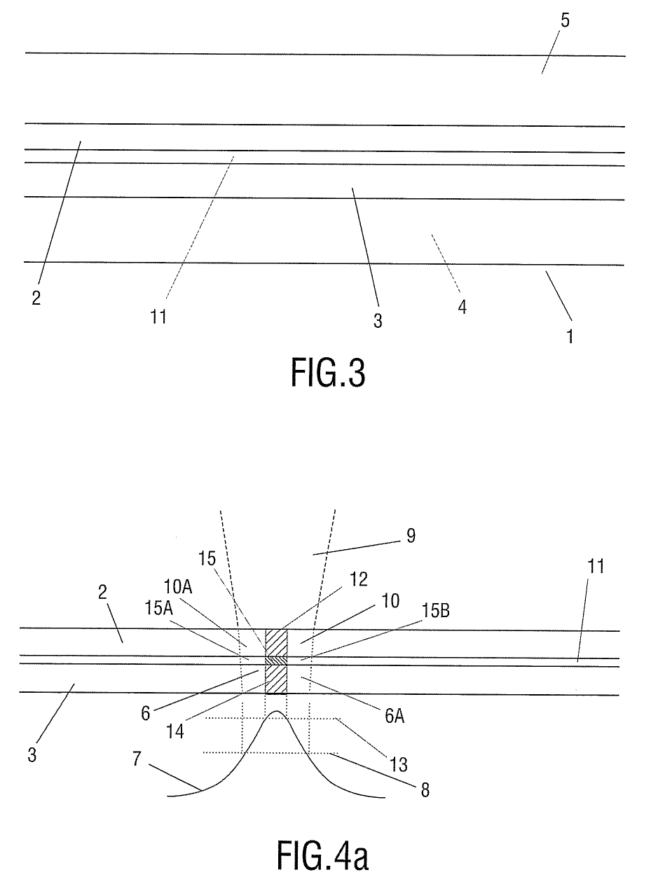

FIG. 3 shows the cross section of a record carrier according to the invention.

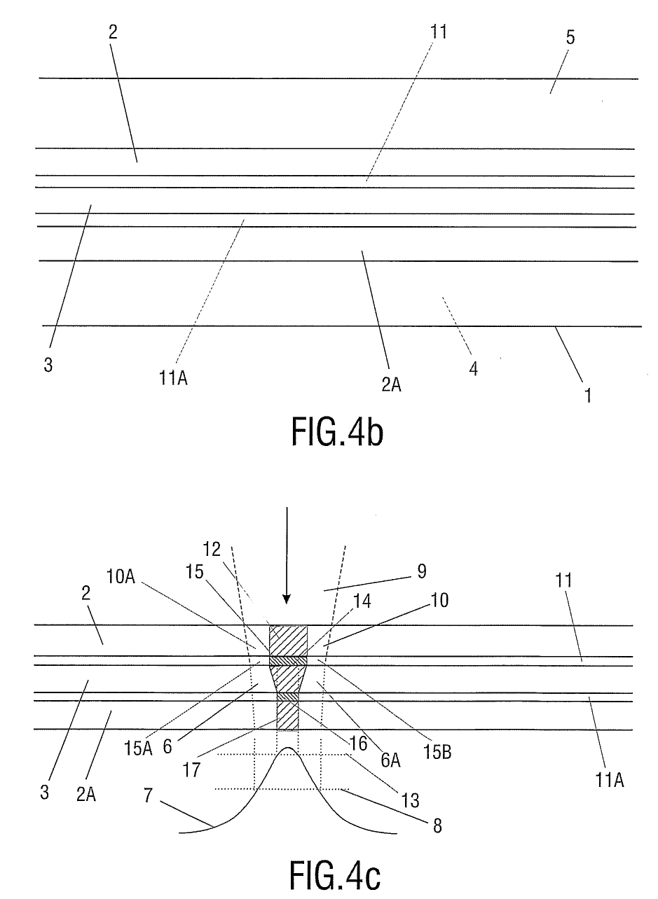

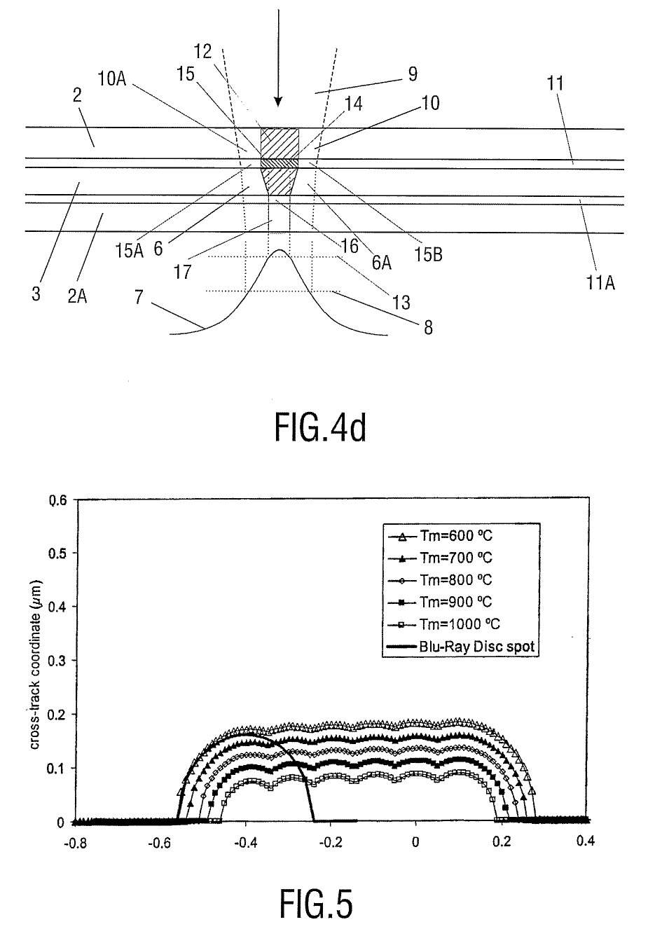

FIG. 4a shows the irradiation of a record carrier according to the invention.

FIG. 4b shows the cross section of a record carrier according to the invention.

FIG. 4c shows the irradiation of a record carrier according to the invention

FIG. 4d shows the irradiation of a record carrier according to the invention

FIG. 5 shows the mark formation on a Si—Cu based record carrier showing the influence of the dose on the mark formation.

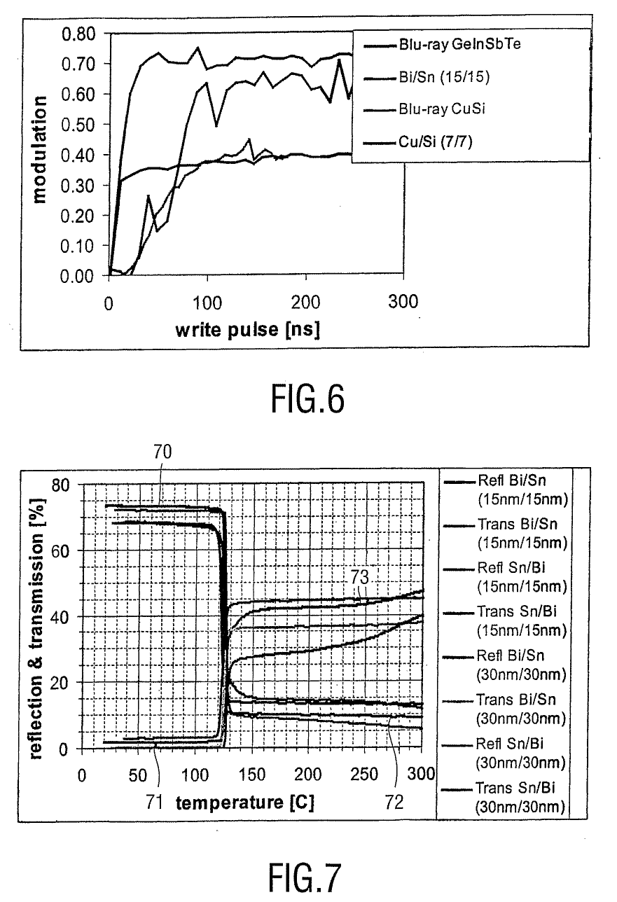

FIG. 6 shows modulation measurements on record carriers with various materials for the first and second layer.

FIG. 7 shows reflection and transmission measurements as a function of the temperature for Bi—Sn and Sn—Bi based record carriers.

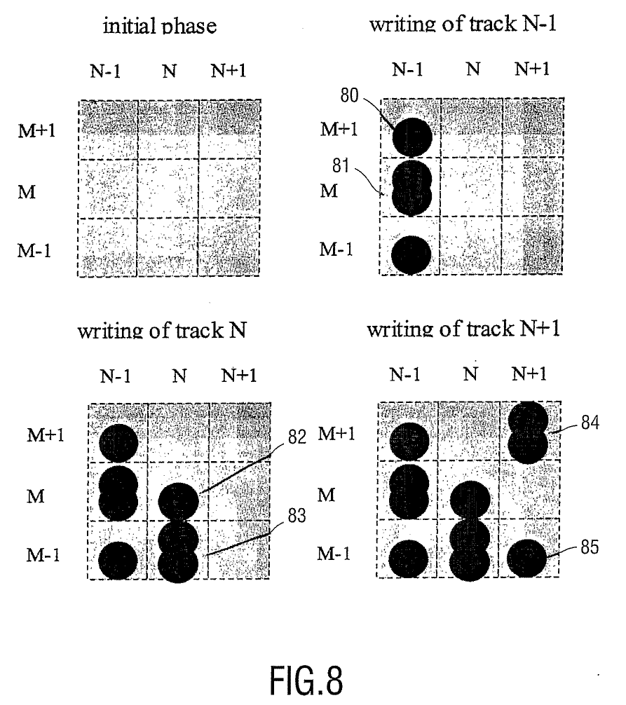

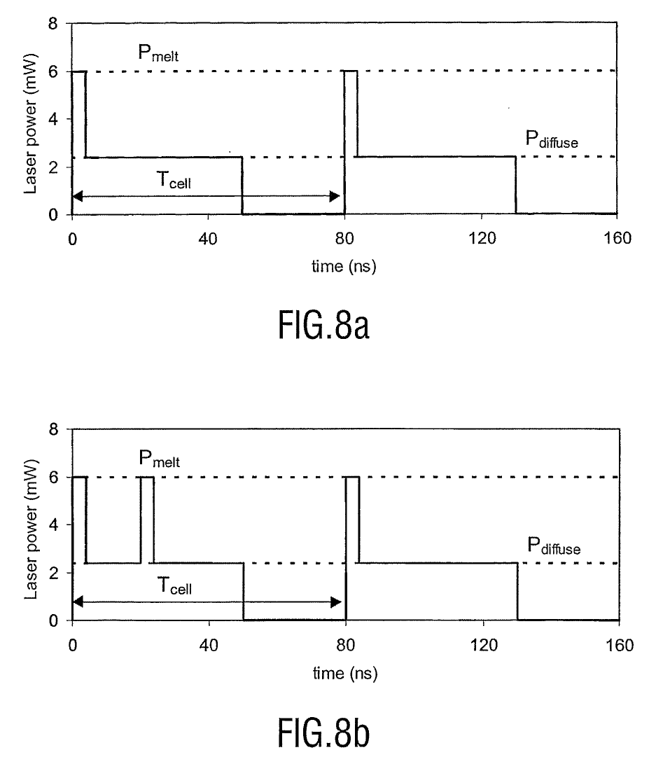

FIG. 8 shows an implementation of a multi level write once recording using a record carrier according to the invention.

FIG. 8a shows a write strategy for a single mark.

FIG. 8b shows a write strategy for a double mark.

FIG. 1 shows the cross section of a record carrier of the prior art

The record carrier 1 has a first layer 2 and adjacent to the first layer 2a second layer 3. The first and second layer 2, 3 are applied to a carrier 4. A protective layer 5 is applied to protect the first and second layer 2, 3 from damage. The protective layer 5 can also be in the form of a second carrier so that the first and second layer 2, 3 are sandwiched between two carriers where each carrier provides mechanical stability and protection.

FIG. 2 shows the irradiation of a record carrier to write a mark on a record carrier of the prior art

In FIG. 2 only the first layer 2 and second layer 3 are shown. The carrier 4 and protective layer 5 are omitted for clarity.

When a region 6, 10 of the first and second layer is irradiated with a dose of laser energy by a laser beam 9 the temperature in this region 6, 10 is raised above the average temperature of the record carrier.

The temperature in a small region 6,10 of the record carrier 1 is increased to the point where the material of the first layer 2 and the material of the second layer 3 start to react and form a new material. This new material in the region 6,10 has a reflectivity that is different from the original material that did not receive a dose of laser energy. In this way a mark is written on the record carrier.

The dose of laser energy 7 is not distributed evenly across the laser beam 9 but has the shape of a gauss curve. The materials in the region 6, 10 irradiated with a laser dose above a certain level 8 of the laser dose 7 will react and form a mark.

Because the material of the first layer 2 and the material of the second layer 3 are in contact with each other on the entire record carrier a slow reaction at, for instance, room temperature in areas that were not irradiated with a dose of laser energy will result in a slow loss of contrast of the record carrier 1 and thus of a reduced reliability both in respect to readability and durability of the record carrier.

FIG. 3 shows the cross section of a record carrier according to the invention The first layer 2 and the second layer 3 are separated by a third layer 11. The third layer prevents that the material of the first layer 2 and the material of the second layer 3 are in contact with each other. Since there is no contact there will be no reaction between the two layers 2, 3 unless the third layer is destroyed or altered such that a reaction becomes possible.

FIG. 4a shows the irradiation of a record carrier with two layers separated by a separation layer.

In order to explain the basic process of recording a mark only three of the five layers are shown in FIG. 4a. In FIG. 4b the recording on a record carrier with the full five layers is described

In FIG. 4a a dose of laser energy 7 is applied to a region 6, 6A, 10, 10A, 12, 14, 15 by a laser beam 9. The region 10, 10A, 12 in the first layer 2 absorbs energy from the laser beam and the temperature of the region 10, 10A, 12 of the first layer increases. The energy not absorbed by the first layer 2 passes on to the third layer 11.

The region 15, 15 A, 15B of the third layer 11 also absorbs energy from the laser beam and the temperature of the region 15, 15A, 15B increases. The energy not absorbed by the third layer 11 passes on to the second layer 3.

The region 6, 6A, 12 of the second layer also absorbs energy from the laser beam and the temperature of the region 6, 6A, 12 increases.

The dose of laser energy 7 is not uniform across the laser beam 9. Only where the dose of laser energy 7 exceeds a certain value 8 the temperature of the region 10, 10A, 12 of the first layer 2 increases enough to enable a reaction of the material of the first layer 2 with the material of the second layer 3. In addition, only where the dose of laser energy 7 exceeds a certain value 8 the temperature of the region 6, 6A, 14 of the second layer 3 increases enough to enable a reaction of the material of the second layer 3 with the material of the first layer 2.

For the third layer 11 the dose of laser energy must reach a higher value 13 than the value required for the first and second layers 2, 3 in order for the temperature of the region 15, 15A, 15B of the third layer 11 to increase to the point where the material of the third layer 11 in the region 15 is broken down. This can be controlled by the choice of material for the third layer or by controlling the absorption by the material of the third layer 11.

Since the higher value of the dose of energy is only reached in a smaller region 15 of the third layer 11, while the surrounding areas 15A, 15B of the third layer 11, only a small region 15 of the third layer is broken down. This area is smaller than the regions 10, 10A, 12, 6, 6A, 14 where the materials of the first and second layers 2, 3 reached the temperature for reaction. Consequently only the material in a small region 12 of the first layer 2 reacts with the material of a small region 14 of the third layer.

FIG. 4b shows the cross section of a record carrier according to the invention The first layer 2 and the second layer 3 are now separated by a third layer 11 and the second layer 3 and the fifth layer 2A are now separated by a fourth layer 11A. The third layer prevents that the material of the first layer 2 and the material of the second layer 3 are in contact with each other. Since there is no contact there will be no reaction between the two layers 2, 3.

FIG. 4c shows the irradiation of a record carrier with three layers separated by two separation layers.

In FIG. 4b a dose of laser energy 7 is applied to a region 6, 6A, 10, 10A, 12, 14, 15, 16, 17 by a laser beam 9. The region 10, 10A, 12 in the first layer 2 absorbs energy from the laser beam and the temperature of the region 10, 10A, 12 of the first layer increases. The energy not absorbed by the first layer 2 passes on to the third layer 11.

The region 15, 15 A, 15B of the third layer 11 also absorbs energy from the laser beam and the temperature of the region 15, 15A, 15B increases. The energy not absorbed by the third layer 11 passes on to the second layer 3.

The region 6, 6A, 12 of the second layer also absorbs energy from the laser beam and the temperature of the region 6, 6A, 12 increases.

The energy not absorbed by the second layer 3 passes on to the fourth layer 11a.

The region 16 of the fourth layer 11a also absorbs energy from the laser beam and the temperature of the region 16 increases. The energy not absorbed by the fourth layer 11a passes on to the fifth layer 2a. The region 17 of the fifth layer 2a also absorbs energy from the laser beam and the temperature of the region 17 increases.

The dose of laser energy 7 is not uniform across the laser beam 9. Only where the dose of laser energy 7 exceeds a certain value 8 the temperature of the region 10, 10A, 12 of the first layer 2 increases enough to enable a reaction of the material of the first layer 2 with the material of the second layer 3. In addition, only where the dose of laser energy 7 exceeds a certain value 8 the temperature of the region 6, 6A, 14 of the second layer 3 increases enough to enable a reaction of the material of the second layer 3 with the material of the first layer 2 and/or the material of the fifth layer 2a.

For the third layer 11 and the fourth layer 11a the dose of laser energy must reach a higher value 13 than the value required for the first layer 2, second layers 3 and fifth layer 2a in order for the temperature of the region 15, 15A, 15B of the third layer 11 and the region 16 of the fourth layer 11a to increase to the point where the material of the third layer 11 in the region 15 and the material of the fourth layer 11a in the region 16 is broken down. This can be controlled by the choice of material for the third layer 11 and the fourth layer 11a or by controlling the absorption by the material of the third layer 11 and the fourth layer 11a. Since the higher value of the dose of energy is only reached in a smaller region 15 of the third layer 11, while the surrounding areas 15A, 15B of the third layer 11, only a small region 15 of the third layer 11 is broken down.

Since the higher value of the dose of energy is only reached, if desired, in a smaller region 16 of the fourth layer 11a, while the surrounding areas of the fourth layer 11a, only a small region 16 of the fourth layer 11a is broken down

These areas are smaller than the regions 10, 10A, 12, 6, 6A, 14 where the materials of the first layer 2, second layer 3 and fifth layer 2a reached the temperature for reaction. Consequently only the material in a small region 12 of the first layer 2 reacts with the material of a small region 14 of the second layer. In addition, if desired, only the material in a small region 17 of the fifth layer 2a reacts with the material of a small region 14 of the second layer

FIG. 4d shows the irradiation of a record carrier with three layers separated by two separation layers.

In FIG. 4d a dose of laser energy 7 is applied to a region 6, 6A, 10, 10A, 12, 14, 15, 16, 17 by a laser beam 9. The region 10, 10A, 12 in the first layer 2 absorbs energy from the laser beam and the temperature of the region 10, 10A, 12 of the first layer increases. The energy not absorbed by the first layer 2 passes on to the third layer 11.

The region 15, 15 A, 15B of the third layer 11 also absorbs energy from the laser beam and the temperature of the region 15, 15A, 15B increases. The energy not absorbed by the third layer 11 passes on to the second layer 3.

The region 6, 6A, 12 of the second layer also absorbs energy from the laser beam and the temperature of the region 6, 6A, 12 increases.

The energy not absorbed by the second layer 3 passes on to the fourth layer 11a.

The region 16 of the fourth layer 11a also absorbs energy from the laser beam and the temperature of the region 16 increases but not sufficient to destroy or alter the region 16 of the fourth layer thus preventing a reaction between the second layer 3 and the fifth layer 2a. The energy not absorbed by the fourth layer 11a passes on to the fifth layer 2a. The region 17 of the fifth layer 2a also absorbs energy from the laser beam and the temperature of the region 17 increases.

The dose of laser energy 7 is not uniform across the laser beam 9. Only where the dose of laser energy 7 exceeds a certain value 8 the temperature of the region 10, 10A, 12 of the first layer 2 increases enough to enable a reaction of the material of the first layer 2 with the material of the second layer 3. In addition, only where the dose of laser energy 7 exceeds a certain value 8 the temperature of the region 6, 6A, 14 of the second layer 3 increases enough to enable a reaction of the material of the second layer 3 with the material of the first layer 2 and/or the material of the fifth layer 2a.

For the third layer 11 and the fourth layer 11a the dose of laser energy must reach a higher value 13 than the value required for the first layer 2, second layers 3 and fifth layer 2a in order for the temperature of the region 15, 15A, 15B of the third layer 11 and the region 16 of the fourth layer 11a to increase to the point where the material of the third layer 11 in the region 15 and the material of the fourth layer 11a in the region 16 is broken down. This can be controlled by the choice of material for the third layer 11 and the fourth layer 11a or by controlling the absorption by the material of the third layer 11 and the fourth layer 11a. By selecting the dose of laser energy 7 such that the third layer is affected but the fourth layer is not affected the formation of the mark is limited to the first and second layer. The fourth layer would as a result of the selection of the dose of laser energy 7 be in tact and prevent a reaction between the second layer 3 and the fifth layer 2a. this affects the reflectivity of the mark thus formed allowing multiple levels of reflection to be achieved: full reflection when no mark is written, medium reflection when only the third layer is affected and low reflection when both the third and fourth layer are affected by the irradiation. Since the higher value of the dose of energy is only reached in a smaller region 15 of the third layer 11, while the surrounding areas 15A, 15B of the third layer 11, only a small region 15 of the third layer 11 is broken down.

Since the higher value of the dose of energy is only reached, if desired, in a smaller region 16 of the fourth layer 11a, while the surrounding areas of the fourth layer 11a, only a small region 16 of the fourth layer 11a is broken down

These areas are smaller than the regions 10, 10A, 12, 6, 6A, 14 where the materials of the first layer 2, second layer 3 and fifth layer 2a reached the temperature for reaction. Consequently only the material in a small region 12 of the first layer 2 reacts with the material of a small region 14 of the second layer.

The Cu—Si system has been proposed as write-once recording system. The systems Bi—Sn and In—Sn have been proposed as write-once recording systems. An important drawback of these systems, in particular if used for two-dimensional data storage, is the thermal cross-write and thermal in-track interference. The proposed barrier layer provides much more stability with respect to these thermal effects. An additional advantage is the increased stability at elevated temperatures.

Several volume ratios are known that provide stable reaction products Siₙ Cuₘ. Experiments performed with a 50-50% volume ratio show at least the feasibility of such an inorganic recording system. Other volume ratios are also possible. Contrast measurements of the initial state and the recorded state were performed with a reflection-transmission measurement system (RTM) for I—Si—Cu—IAg samples, I denoting a ZnS—SiO2 dielectric layer. The recorded state was obtained after thermal annealing of the stack to initiate the chemical reaction (the thermal annealing was performed on the thermal RTM set-up). The Si and Cu layer thickness was equal and taken to be 5, 7 and 9 nm. Contrast measurements performed for a variable first I layer thickness (varied between 20 and 100 nm) are shown in FIG. 4e for the three Si—Cu layer thickness (all having a 50-50% volume ratio). The 9 nm Si and Cu results in almost 80% contrast at an II layer thickness of about 50 nm.

FIG. 5 shows the mark formation on a Si—Cu based record carrier showing the influence of the dose on the mark formation.

Numerical simulations of mark formation have been carried out for a M-I2—P—I1 recording stack to illustrate the super resolution properties of the proposed recording stack (I1 and 12 denote the ZnS—SiO2 dielectric layers, P denotes the compound recording layer (P═Si—I—Cu) and M is the metallic heat sink layer (in case of Ag). The layer thickness of the layers were Ag—I2—(Cu—I—Si)−I1=60-44-(5-2-5)-20 nm. Mark formation was defined as the in-plane area in the recording stack that exceeded the melting temperature of the interface barrier, in between the Si and Cu layer. Half inplane mark sizes are given in FIG. 5 as a function of the melting temperature of the barrier layer for a sequence of six write pulses. It is noted that such a write strategy is used to write longer marks in a run-length modulation code. The result of the first write pulse in the sequence, corresponding to the leading edge of the calculated mark, illustrates more or less the result of a single write pulse strategy, for example as used in a multi-level recording scheme with a fixed cell length. Mark profile 50 is the result of a relatively low melting temperature while mark profile 51 is the result of a relatively high melting temperature. The difference in mark size illustrates that actually the melting temperature in combination with write power and optical properties of the recording stack can be used to control the mark size. The blue circle 52 (with Ro radius) denotes the 1/e size of blue laser spot. It is clear that for a relatively high melting temperature, only a very small aperture is created in the barrier layer to allow physical contact between the two reactive recording layers Si and Cu.

Possibilities for the thin barrier layer are for example ZnS—SiO2, SiC, Al2O3, Si3N4, SiO2, C, KCl, LiF, NaCl, Pt, Au, Ag, etc. Requirements for the separating layer, i.e. barrier layer, are:

1. The melting temperature of the barrier layer should be higher than the mixing temperature of the Cu—Si, or Bi—Sn, or In—Sn systems. It is foreseen that a melting temperature equal to or a little bit lower than the reaction temperature of the CuSi, Bi—Sn or In—Sn systems leads also to smaller bits but the possibly incomplete reaction/mixing between the different layers may lead to lower modulation.
2. Chemical stability at room temperature.
3. Strong threshold behavior: melting causes the formation of aperture, at moderate temperature rise no diffusion through layer possible.

FIG. 6 shows modulation measurements on record carriers with various materials for the first and second layer.

In FIG. 6, results of static tester measurements on Cu—Si disc and on the (ZnS—SiO2)—Cu—Si—(ZnsS—SiO2) and SiN—Bi—Sn—SiN discs are compared to the results obtained for a standard phase-change Blue-ray Disc. Shown is the signal modulation (ratio of the peak-peak signals from the longest run length (in this case I8) to the signal amplitude) as a function of the write pulse length. The standard Blu-ray Disc is based on the GeInSbTe phase-change material that can be reversibly switched between an amorphous and a crystalline state. The Blu-ray Cu—Si was a test disk, the CuSi was a home-made disc with layer thickness 7 nm and the BiSn system had 15 nm layer thickness. It can be seen from the figure that a modulation equal or even higher than that for a standard Blu-Ray Disc can be obtained with the proposed write-once systems.

FIG. 7 shows reflection and transmission measurements as a function of the temperature for Bi—Sn and Sn—Bi based record carriers.

Several volume ratios are known that provide stable reaction products SiₙCuₘ, experiments were performed with a 50-50% volume. Contrast measurements of the initial state and the recorded state were performed using reflection and transmission measurements for I—Si—Cu—I—Ag samples, I denoting a ZnS—SiO2 dielectric layer. Contrast is defined as the next ratio: Contrast=(Rinit-R-written)/Rinit. Contrast measurements are given in FIG. 9 as a function of the dielectric layer II for three layer thickness, 5, 7, and 9 nm. It is seen that good contrast can be obtained for a volume ratio of 50% for three shown layer thicknesses. For a five layer stack with 3 recording layers and two separating layers additional contrast can be obtained by causing a reaction between both the first layer and the second layer and the second layer and the fifth layer.

The recorded state was obtained after thermal annealing of the stack to initiate the chemical reaction. The results of these thermal reflection and transmission measurements (RTM measurements) on the Bi—Sn system are shown in FIG. 7. Shown are the experimental results for two layer thicknesses, 15/15 and 30/30 nm, all having for a 50% volume ratio and two orientations, SiBi and BiSn. A threshold kind of reaction takes place at about 140° C. The reflection is initially at around 70%, indicated with 70, while it drops to values of around 10-15%, indicated with 72. On the contrary, the transmission is initially below 5%, indicated with 71 while it increases to above 30%, indicated with 73.

The low transmission of both the initial and written state illustrates that such recording stacks can also be used in transparent mode, such as the first recording stack in a dual-layer disc

FIG. 8 shows an implementation of a multi level write once recording using a record carrier according to the invention.

A schematic of 2D multi-level recording is shown in FIG. 8. We have considered a rectangular grid, but a hexagonal structure (honeycomb structure) may be possible as well (such a scheme is used in the 2DOS project). In the initial phase, the matrix of 9 cells, indicated by the tracks N−1, N and N+1 and the subsequent cells M−1, M and M+1, are unwritten (also track N−2 is unwritten). In step 1, data is written in track N1. The mark size is only controlled by the write power. In step 2, data is written in track N. In step 3, data is written in track N+1.

A great advantage of the proposed recording stack and method is the ability to write marks at super resolution, i.e. smaller than the optical spot. This allows a significant reduction of the track pitch. A possibility is then to use the method and record carrier to write a two-dimensional data pattern.

In case the track pitch is significantly reduced, the measured reflection from track N comprises the contribution from tracks N−1 and N+1 as well (optical cross-talk). The spot intensity is typically a Gauss (something between a Gauss and Airy). The readout signal should therefore be seen as a convolution of the intensity profile and the present data. Typically, the marks in the central track will have a more significant contribution to the total reflected signal than the marks in the adjacent tracks. In most optical recording application, the contribution from the side tracks is unwanted, but we can design the system such that it optimally uses optical cross-talk.

The pit formation can be controlled by a proper selection of the write strategy (pulse times and pulse powers). The write strategy needs to be optimized at least for three subsequent cells (M−1, M and M+1). If the previous cell M−1 is written, the heat dissipated in this location may affect the writing of cell M (pre heat effect). Also, the writing of cell M+1 may affect the previously written cell M, (so-called post heat effect). The post and pre heat effects need to be controlled in order to control the writing of the cell M.

Possible parameters to play around with are the power and length of the write pulse and a sort of preheat pulse for the next mark to be written and the possible cooling gap. An example of such a write strategy is given in the FIG. 8a. The pulse height Pmelt determines the size of the molten area. The duration and power of Pdiffuse can be used to control the degree of diffusion of layer 1 and layer 2. The cooling gap is needed to cool down the recording stack and can be used control the thermal interference (pre heat effect) in the recording stack. (bias level). The track pitch, the power levels and pulse duration are closely related and need therefore to be optimized in a cluster optimization algorithm

Synchronization of pits is very important since the pits in the adjacent tracks need to be placed with high spatial accuracy with respect to pits in the central track. There are two options: 1. Pre-mastered lands or spikes for synchronization. 2. Written long (e.g. 120) pits/marks that enable the reconstruction of the synchronization pattern. Synchronization is done by measuring the long syncs in the adjacent track via optical cross talk. Since the track pitch is much smaller than the optical spot size (diffraction limit), it is expected that the adjacent marks will be detected when focusing on the central track.

A multi-level pattern can be generated by writing overlapping marks, for example 80 is a single mark and 81 is a double mark (2 overlaying marks), both indicated in FIG. 8. In the next write cycle, pattern 83 and 82 are written. In a third write cycle, pattern 85 and 84 are written in track N+1. A typical write strategy used to write a double mark is indicated in FIG. 8b.

1. A method for recording information on an optical disc comprising a first layer of a first material and a second layer of a second material, the method comprising irradiating a region of the optical disc with a dose of laser energy where the first material of the first layer reacting with the second material of the second layer in the region irradiated with the dose of laser energy,
characterized in that a third layer, located between the first layer and the second layer when irradiated with a first dose of laser energy enables the reaction between the first material and the second material in the region irradiated by the first laser dose and that a fourth layer, located between a fifth layer of the first material and the second layer, when irradiated with a second dose of laser energy enables a further reaction between the first material and the second material in the region irradiated by the second laser dose.

2. A method for recording information on an optical disc as claimed in claim 1,
characterized in that the reaction or the further reaction is a chemical reaction

3. A method for recording information on an optical disc as claimed in claim 1,
characterized in that the reaction or the further reaction is a melting to form an alloy of the first material and the second material.

4. A method for recording information on an optical disc as claimed in claim 1,
characterized in that the reaction or the further reaction is an organic reaction

5. A method for recording information on an optical disc as claimed in claim 1,
characterized in that the reaction is enabled by permanently altering the region in the third layer and that the further reaction is enabled by permanently altering the region in the fourth layer.

6. A method for recording information on an optical disc as claimed in claim 1,
characterized in that the permanently altering is achieved by irradiating an organic material in the third layer or the fourth layer.

7. A method for recording information on an optical disc as claimed in claim 1,
characterized in that the third layer and the fourth layer requires a higher dose of laser energy for enabling the reaction than required for the reaction of the first material with the second material.

8. A method for recording information on an optical disc as claimed in claim 1,
characterized in that the first material is Si and that the second material is Cu.

9. A method for recording information on an optical disc as claimed in claim 1,
characterized in that the first material is Bi and that the second material is Sn

10. A method for recording information on an optical disc as claimed in claim 1,
characterized in that the first material is In and that the second material is Sn

11. A method for recording information on an optical disc as claimed in claim 1,
characterized in that the third layer and the fourth layer comprises a third material selected from the group of ZnS—SiO2, SiC, Al2O3, Si3N4, SiO2, C, KCl, LiF, NaCl, Pt, Au, Ag.

12. A method for recording information on an optical disc as claimed in claim 1,
characterized in that the information is recorded using multilevel recording by creating a first level using the reaction between the first layer and the second layer and by creating a second level using the further reaction between the second layer and the fifth layer.

13. A record carrier comprising a first layer of a first material and a second layer of a second material
characterized in that a third layer of a third material is located between the first layer and the second layer that enables a reaction between the first material and the second material in a region when irradiated in that region and that a fourth layer of the third material is located between the second layer and a fifth layer where the fourth layer enables a further reaction between the first material in the fifth layer and the second material in the second layer.

14. A record carrier as claimed in claim 13,
characterized in that the reaction or the further reaction is a chemical reaction

15. A record carrier as claimed in claim 13,
characterized in that the reaction or the further reaction is a melting to form an alloy of the first material and the second material

16. A record carrier as claimed in claim 13,
characterized in that the reaction or the further reaction is enabled by permanently altering the third layer.

17. A record carrier as claimed in claim 13,
characterized in that the third layer and the fourth layer require a higher dose of laser energy for enabling the reaction than required for the reaction and further reaction of the first material with the second material.

18. A record carrier as claimed in claim 17,
characterized in that the first material is Si and that the second material is Cu

19. A record carrier as claimed in claim 17,
characterized in that the first material is Bi and that the second material is Sn

20. A record carrier as claimed in claim 17,
characterized in that the first material is In and that the second material is Sn

21. A record carrier as claimed in claim 17,
characterized in that the third layer comprises a third material selected from the group of ZnS—SiO2, SiC, Al2O3, Si3N4, SiO2, C, KCl, LiF, NaCl, Pt, Au, Ag.

22. A record carrier as claimed in claim 13,
characterized in that the record carrier comprises a further recording layer.

23. A recording device for recording information on an optical disc comprising a control circuit for controlling a dose of irradiation emitted by a laser and a detection circuit for detecting a type of an optical disc,
characterized in that the control circuit, when the detection circuit detects a record carrier comprising a first layer of a first material and a second layer of a second material where a third layer of a third material is located between the first layer and the second layer and where a fourth layer of a third material is located between the second layer and a fifth layer of the first material where that third layer enables a reaction between the first material and the second material in a region when that third layer is irradiated in that region with a dose of irradiation, adjusts the dose of irradiation such that the third layer enables the reaction where that fourth layer enables a further reaction between the first material and the second material in the region when that fourth layer is irradiated in that region with a further dose of irradiation, adjusts the further dose of irradiation such that the fourth layer enables the reaction.

24. A recording device for recording information on an optical disc as claimed in claim 23,
characterized in that the recording is a multilevel recording

25. A recorder for recording information on an optical disc as claimed in claim 24,
characterized in that the control circuit of the recorder controls the irradiation emitted by the laser such that one region is irradiated or multiple overlapping regions are irradiated.
